(19) United States
(12) Patent Application Publication
(10) Pub. No.: US 2017/0131873 A1
(43) Pub. Date: May 11, 2017

(54) NATURAL USER INTERFACE FOR SELECTING A TARGET ELEMENT

(71) Applicant: Microsoft Technology Licensing, LLC., Redmond, WA (US)

(72) Inventors: Kimberly Koenig, Seattle, WA (US); Shiraz M. Somji, Bellevue, WA (US); Evgeny Agafonov, Redmond, WA (US)

(73) Assignee: MICROSOFT TECHNOLOGY LICENSING, LLC., Redmond, WA (US)

(21) Appl. No.: 14/936,149

(22) Filed: Nov. 9, 2015

(51) Int. Cl. G06F 3/0484; G06F 17/24; G06F 3/0482; G06F 3/0488

(52) U.S. Cl. CPC G06F 3/04842; G06F 3/04883; G06F 3/04845; G06F 3/04847; G06F 17/24; G06F 3/0482

(57) ABSTRACT

Selecting an intended target element via gesture-dependent hit testing is provided. Aspects provide for receiving a gesture input on or proximate to a selection handle and neighboring content; performing a hit test for determining whether a gesture input contact area and a selection handle hit target area overlap and/or exceed an upper limit overlap value; performing gesture recognition for determining whether the gesture input is a static or a manipulation gesture; selecting an intended target element based on at least one of the results of the hit test and the gesture recognition; and manipulating the intended target element in accordance with the manipulation gesture.

### BACKGROUND

When using an application on a computing device for interacting with content, the application typically provides selectable user interface elements, such as selection handles, that allow a user to create and interact with selected content. Manipulation of the selection handles can be difficult, particularly when utilizing natural user interface input methods (e.g., touch, motion, head movement, eye or gaze movement), which can be less precise than mouse or pointer input methods.

For example, when trying to manipulate a selection handle via a gesture input, the target of the gesture input may be mistakenly applied to content neighboring the selection handle. Or, as another example, when trying to select content neighboring the selection handle, the target of the gesture input may be mistakenly applied to the selection handle. Accordingly, a user may have to try multiple times to select an intended target element, while the computing device's efficiency is decreased from processing multiple inputs.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

Aspects are directed to an automated system, method, and device for selecting an intended target element via gesture-dependent hit testing. According to an example, aspects provide for receiving a gesture input on or proximate to a selection handle and neighboring content; performing a hit test for determining whether a gesture input contact area and a selection handle hit target area overlap and/or exceed an upper limit overlap value; performing gesture recognition for determining whether the gesture input is a static or a manipulation gesture; and selecting an intended target element based on at least one of the results of the hit test and the gesture recognition.

Examples are implemented as a computer process, a computing system, or as an article of manufacture such as a device, computer program product, or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a simplified block diagram showing components of an example system for gesture-dependent hit testing for target element selection;

FIGS. 2A and 2B are example illustrations showing interaction with selection handles displayed on a display screen of a computing device;

FIG. 3 is a simplified block diagram showing various components of a target element selection engine;

FIGS. 4A-4F illustrate a first example of a gesture-dependent hit testing scenario;

FIGS. 5A-D illustrate a second example of a gesture-dependent hit testing scenario;

FIG. 6A-F illustrate a third example of a gesture-dependent hit testing scenario;

FIGS. 7A-7C are flow charts showing general stages involved in an example method for gesture-dependent hit testing for target element selection;

FIG. 8 is a block diagram illustrating example physical components of a computing device;

FIGS. 9A and 9B are simplified block diagrams of a mobile computing device; and

FIG. 10 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer storage media for gesture-dependent hit testing for target element selection. In some examples, a target element selection engine is operative to prioritize a selection handle as the target element for a manipulation gesture input (e.g., drag gesture), and prioritize neighboring content as the target element for a static gesture input (e.g., tap gesture).

In some examples, a target element selection system includes one or more processors for executing programmed instructions, memory coupled to the one or more processors for storing program instruction steps for execution by the computer processor, and a target element selection engine for receiving a gesture input on or proximate to a selection handle; performing a hit test for determining whether a gesture input contact area and a selection handle hit target area overlap and/or exceed an upper limit overlap value; performing gesture recognition for determining whether the gesture input is a static or a manipulation gesture; and selecting an intended target element based on at least one of the results of the hit test and the gesture recognition.

In some examples, a method for selecting an intended target element via gesture-dependent hit testing includes receiving a gesture input on or proximate to a selection handle; performing a hit test for determining whether a gesture input contact area and a selection handle hit target area overlap and/or exceed an upper limit overlap value; performing gesture recognition for determining whether the gesture input is a static or a manipulation gesture; and selecting an intended target element based on at least one of the results of the hit test and the gesture recognition.

In some examples, a device includes a display screen operative to receive natural user interface input and a target element selection engine for receiving a gesture input on or proximate to a selection handle; performing a hit test for determining whether a gesture input contact area and a selection handle hit target area overlap and/or exceed an upper limit overlap value; performing gesture recognition for determining whether the gesture input is a static or a manipulation gesture; and selecting an intended target element based on at least one of the results of the hit test and the gesture recognition.

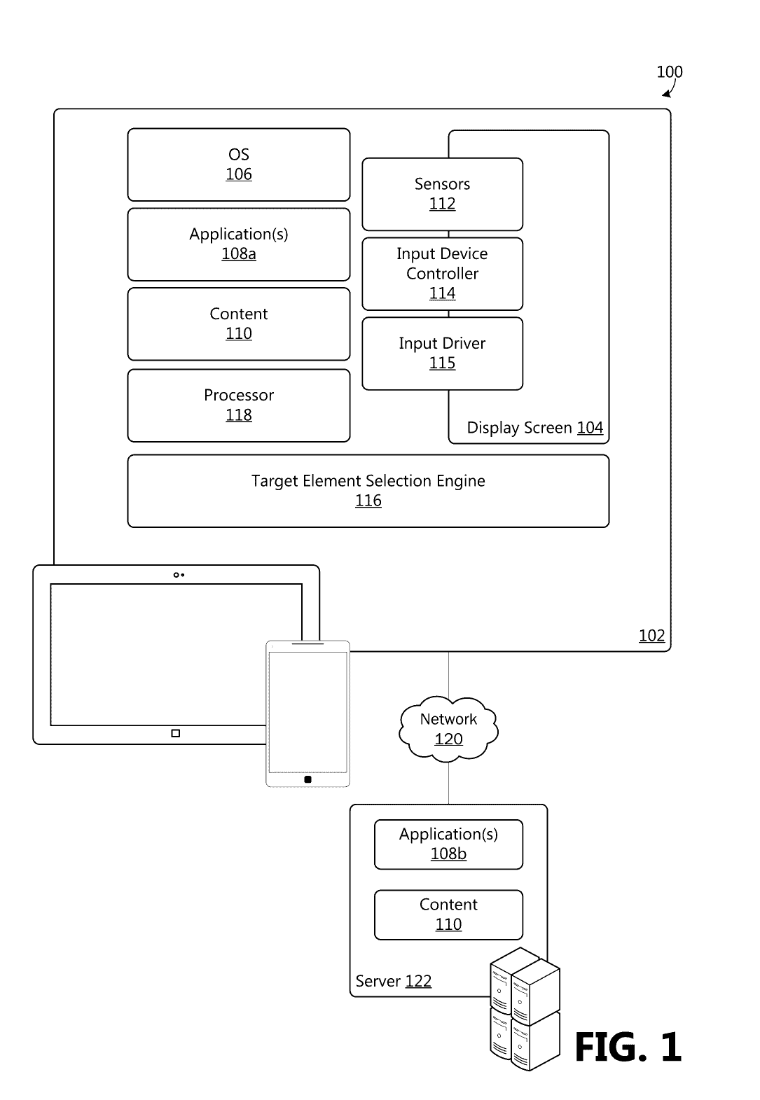

With reference now to FIG. 1, a simplified block diagram of one example of a target element selection system 100 is shown. As illustrated, the target element selection system 100 includes a computing device 102. The computing device 102 illustrated in FIG. 1 is illustrated as a mobile computing device (e.g., a tablet computer or a mobile communication device); however, as should be appreciated, the computing device 102 may be one of various types of computing devices (e.g., a tablet computing device, a desktop computer, a mobile communication device, a laptop computer, a laptop/tablet hybrid computing device, a large screen multi-touch display, a gaming device, a smart television, a wearable device, or other type of computing device) for executing applications 108a,b (collectively, 108) for performing a variety of tasks.

A user may utilize an application 108 on the computing device 102 for a variety of tasks, which may include, for example, to write, calculate, draw, organize, prepare presentations, send and receive electronic mail, take and organize notes, make music, and the like. Applications 108 may include thick client applications 108a, which may be stored locally on the computing device 102, or may include thin client applications 108b (i.e., web applications) that may reside on a remote server 122 and accessible over a network 120, such as the Internet or an intranet. A thin client application 108b may be hosted in a browser-controlled environment or coded in a browser-supported language and reliant on a common web browser to render the application 108b executable on the computing device 102. According to an aspect, the application 108 is a program that is launched and manipulated by an operating system 106, and manages content 110 published on a display screen 104. According to an example, the operating system 106 runs on a processor 118, and supports execution of the applications 108.

An application 108 is operative to provide a user interface (UI) for editing and otherwise interacting with a document, which includes textual and other content 110. According to examples, the UI is a natural user interface (NUI) that enables a user to interact with the computing device 102 in a “natural” manner, for example, free from artificial constraints imposed by input devices such as mice, keyboards, remote controls, and the like. According to an example, the display screen 104 is operative to receive NUI input (herein referred to as a gesture input) via a sensor 112 operatively attached to the display screen 104. For example, the sensor 112 may include a touchscreen, motion gesture detection system, head, eye, or gaze tracking mechanism, or other NUI input recognition system configured to detect when a physical object (e.g., finger, stylus) comes into contact with the display screen 104, detect a gesture (e.g., on the display screen 104 or adjacent to the display screen 104), or detect air gestures, head, or eye tracking.

An input device controller 114 is illustrative as an interface between the sensor 112 and the display screen 104. For example, the input device controller 114 is operative to receive information associated with a gesture input from the sensor 112, and translate the gesture input into an input message that the operating system 106 or application 108 can understand. An input driver 115 is illustrative of a device, device firmware, or software application that allows the operating system 106 or application 108 to communicate with the input device controller 114.

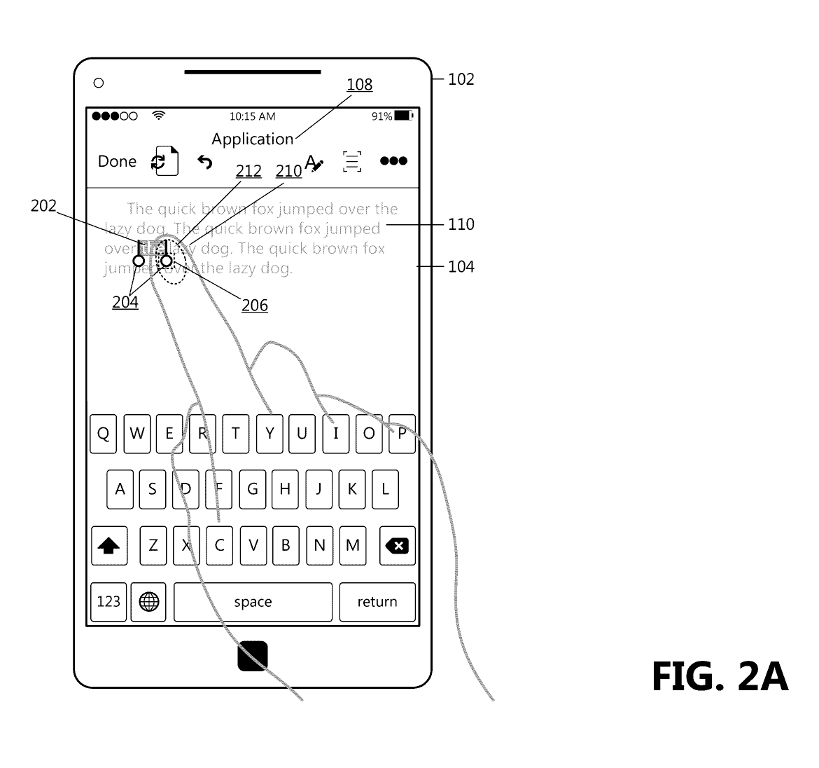

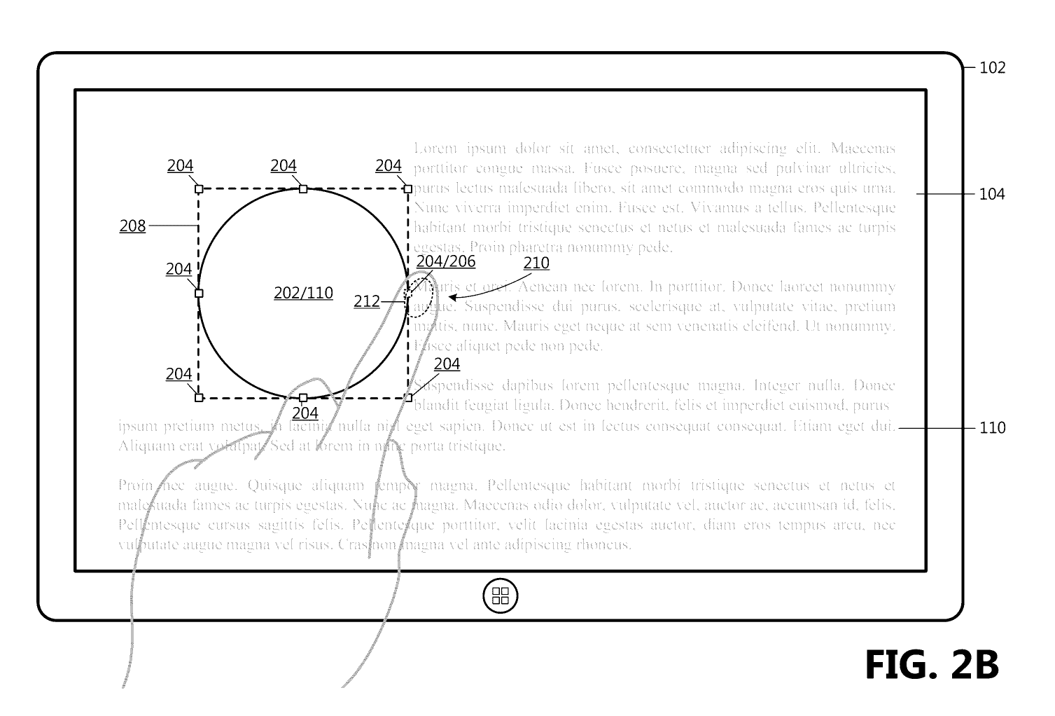

The display screen 104 is configured to present content 110 associated with an application 108 and UI elements for selection of or interaction with the content 110 to a user. For example, and as illustrated in FIG. 2A, an application 108 may activate and provide one or more selection handles 204 on the display screen 104, which identify an interaction target (sometimes referred to as a “hit target”), and provide an indication to the user and to the application 108 that an element or object is currently selected (i.e., a selection 202) and ready for further input, such as adjustment or modification. In some examples, the one or more selection handles 204 are displayed on the two endpoints of a selected block of text (as illustrated in FIG. 2A). In other examples, the one or more selection handles 204 surround a border 208 of a selected object (as illustrated in FIG. 2B).

As described above and as illustrated in FIGS. 2A and 2B, when a user performs a gesture to select a target element (i.e., a selection handle 204) associated with a selection 202 or content 110 proximate to a selection handle 204 (herein referred to as neighboring content 210), determining which target element the user intended to select can be difficult. Accordingly, a target element selection engine 116 is provided. The target element selection engine 116 is illustrative of a device, device firmware, or software application operative to: receive a gesture input on or proximate to a selection handle; perform a hit test for determining whether a gesture input contact area and a selection handle hit target area overlap and/or exceed an upper limit overlap value; perform gesture recognition for determining whether the gesture input is a static or a manipulation gesture; and select an intended target element based on at least one of the results of the hit test and the gesture recognition.

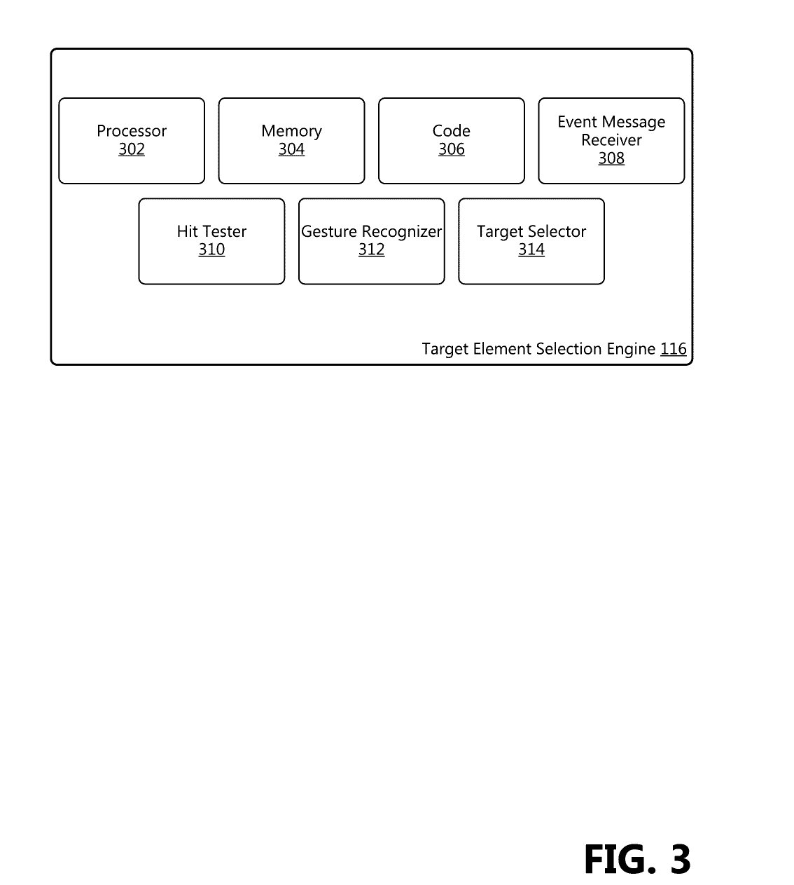

With reference now to FIG. 3, a simplified block diagram illustrating components of the target element selection engine 116 is shown. According to an aspect, the target element selection engine 116 includes at least one processor 302, at least one memory 304 coupled to the at least one processor 302, and code 306 which is executable by the processor 302 to cause: an event message receiver 308 to receive an input message associated with gesture input on or proximate to a selection handle 204; a hit tester 310 to perform a hit test; a gesture recognizer 312 to identify whether the gesture input includes a manipulation gesture; and a target selector 314 to determine a target element for which the gesture input is intended, and perform an action according to the identified gesture input and the intended target element.

According to examples, the event message receiver 308 is illustrative of a software module, system, or device operable to receive an input message associated with a gesture input. For example, in a touch-based NUI system, a gesture input begins with a first gesture event when a user touches the display screen 104 with a finger or other object (e.g., stylus). According to an example, the event message receiver 308 receives an input message associated with a gesture input on or proximate to a selection handle 204. The gesture input may include a plurality of gesture events (i.e., gesture sequence). For example, additional gesture events in a gesture sequence may occur when the user moves the finger or other object. The gesture input is translated into an input message via the input device controller 114, and communicated to the event message receiver 308 via the input driver 115. The input message comprises various pieces of information associated with the gesture input. For example, the pieces of information include coordinates of where on the display screen 104 the gesture input occurred, an identifier for the gesture input, and dimensions of the selection point area.

According to examples, the hit tester 310 is illustrative of a software module, system, or device operative to perform a hit test on the gesture input. With reference gain to FIGS. 2A and 2B, the hit tester 310 is operative to analyze the input message for determining whether an area associated with the gesture input (i.e., selection point area 212) intersects with a target area (i.e., hit target 206) of a selection handle 204 proximate to the selection point area 212. According to examples, the application 108 provides information to the hit tester 310, such as coordinates of the locations of selection handles 204 and the coordinates of the hit targets 206 associated with the selection handles 204.

The hit tester 310 is further operative to determine an amount of overlap of the selection point area 212 and the selection handle hit target 206, compare the amount of overlap with a first predetermined threshold overlap value, and determine whether the amount of overlap meets or exceeds the first predetermined threshold overlap value. According to an example, the first predetermined threshold overlap value is 1%. Accordingly, a positive determination is made when there is any overlap of the selection point area 212 and the selection handle hit target 206.

According to examples, the hit tester 310 is further operative to compare the overlap of the selection point area 212 and the selection handle hit target 206 with a second predetermined threshold overlap value, which is an upper limit overlap value. For example, when the amount of overlap meets or exceeds the first predetermined threshold overlap value, and is less than the second predetermined threshold overlap value, the hit tester 310 determines that the gesture input is considered a “hit around.” That is, without further analysis, the intended target element is not yet determined. According to an example, the upper limit overlap value is 100%. That is, according to an example, unless the selection point area 212 and the selection handle hit target 206 fully overlap, without further analysis, the hit tester 310 is not confident that the intended target element is the selection handle 204.

When the overlap of the selection point area 212 and the selection handle hit target 206 meets or exceeds the first threshold value (e.g., positive determination of overlap) and does not exceed the second threshold value (e.g., not a complete overlap), the selection of the intended target element is gesture-dependent. According to an aspect, the target element selection engine 116 utilizes the gesture recognizer 312 to identify whether the gesture input is a static gesture, such as a tap gesture, or whether the gesture input includes a manipulation gesture, such as a drag gesture. Depending on whether the gesture input is identified as a static gesture or a manipulation gesture, the target element selection engine 116 is operative to prioritize either the selection handle hit target 206 or the neighboring content 210 as the target element of the gesture input. For example, if the gesture input is determined to be a manipulation gesture, the target element selection engine 116 prioritizes the selection handle 204 hit target. If the gesture input is determined to be a static gesture, the target element selection engine 116 prioritizes the neighboring content 210 as the target element.

According to an example, when the first predetermined threshold overlap value is 1% and the second predetermined threshold overlap value is 100%, and the determined overlap of the selection point area 212 and the selection handle hit target 206 is greater than or equal to the first predetermined threshold overlap value and less than the second predetermined threshold overlap value, the target element selection engine 116 performs gesture recognition for determining the intended target element of the gesture input. One of ordinary skill in the art will appreciate, however, that the threshold overlap values of 1% and 100% are provided only as an example; the disclosure is not limited hereby.

According to another example, when the amount of overlap of the selection point area 212 and the selection handle hit target 206 is determined to be 100%, the hit tester 310 determines the gesture input is a “real hit.” That is, the target element selection engine 116 determines with a high level of confidence that the user is targeting the selection handle 204.

According to examples and with reference again to FIG. 3, the gesture recognizer 312 is illustrative of a software module, system, or device operative to identify whether the gesture input is a static gesture or includes a manipulation gesture, such as a slide or drag gesture (herein referred to as a drag gesture). As described above, a gesture input may comprise a gesture sequence of a plurality of gesture events. A gesture input may include one or a combination of gestures. For example, a gesture input may include at least one of: a tap gesture, where a finger or object touches the display screen 104 and lifts up; a press and hold gesture, where a finger or object touches the display screen 104 and stays in place; and a drag gesture, where one or more fingers or objects touch the display screen 104 and move in the same direction.

According to examples, the target selector 314 is illustrative of a software module, system, or device operative to determine a target element for which the gesture input is intended. For example, based on whether the selection point area 212 overlaps the hit target 206 of the selection handle 204, the amount of overlap, and whether the gesture input includes a drag gesture, the target selector 314 is operative to determine the intended target element of the gesture input. That is, the target selector 314 is operative to determine to which object the received gesture input applies: the selection handle 204 or neighboring content 210.

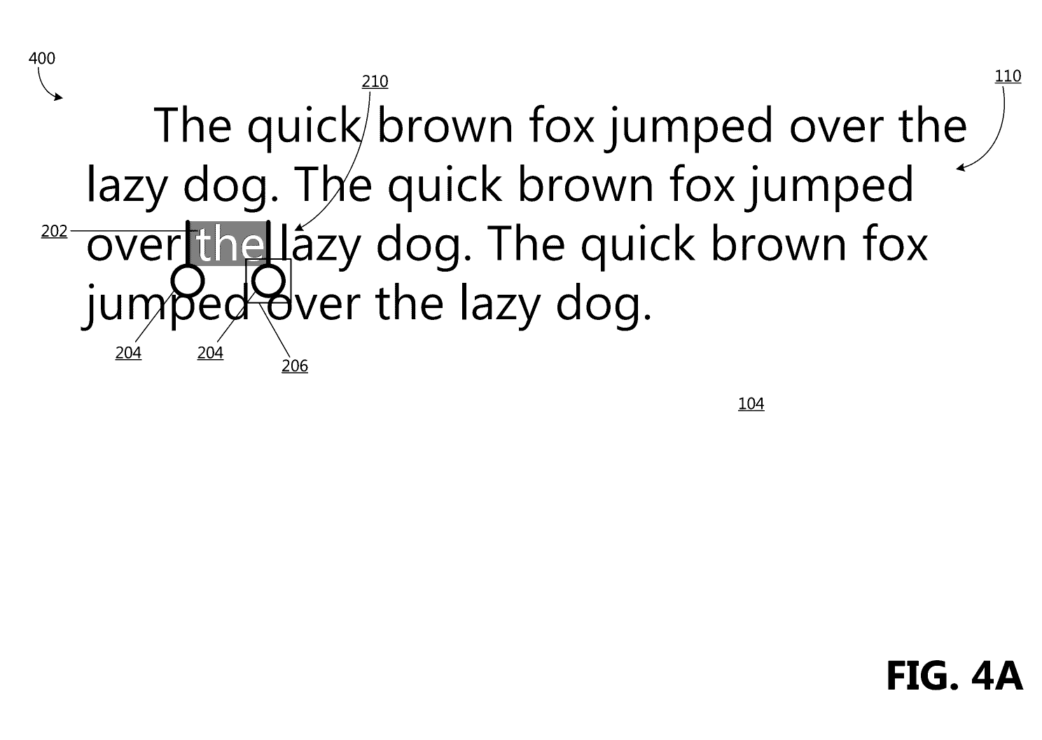

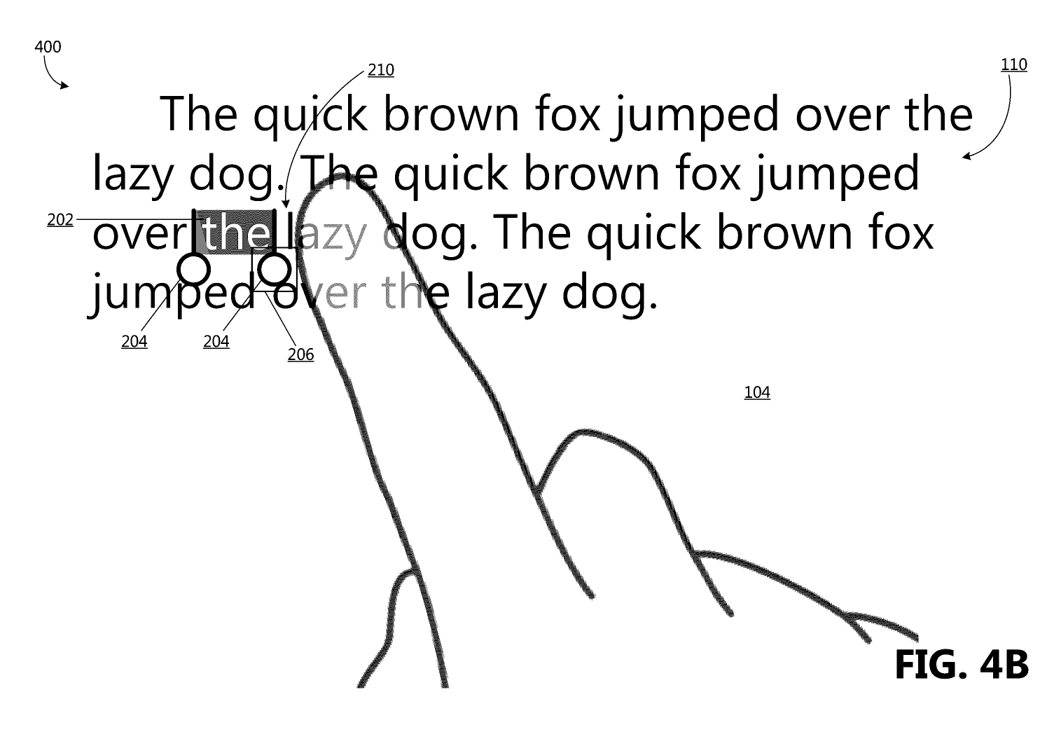

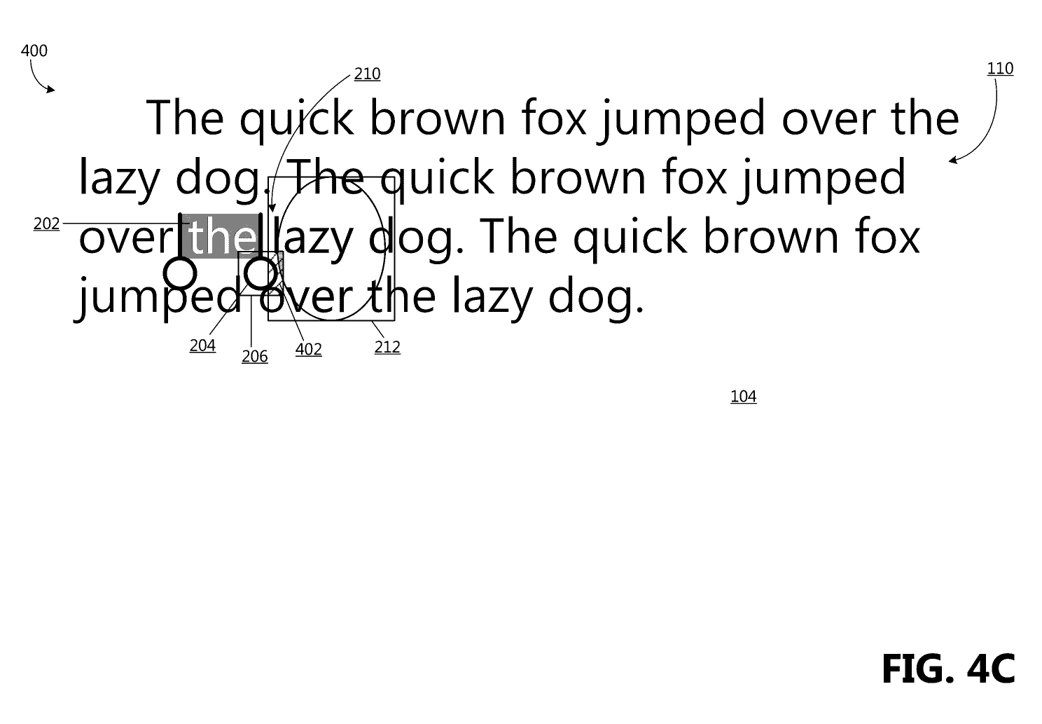

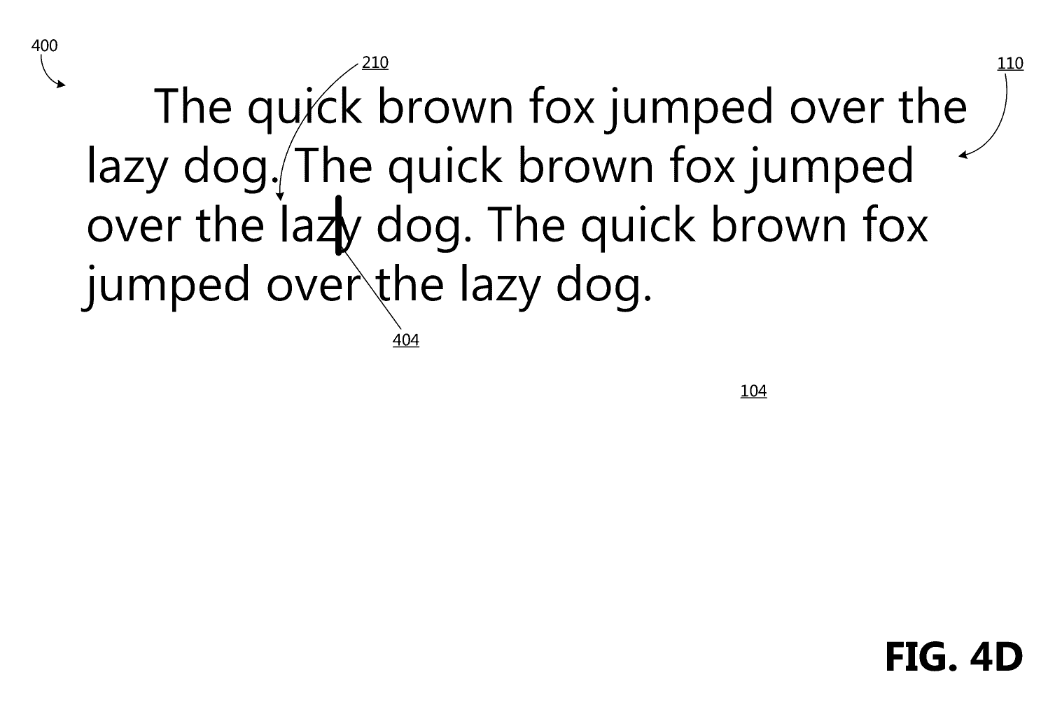

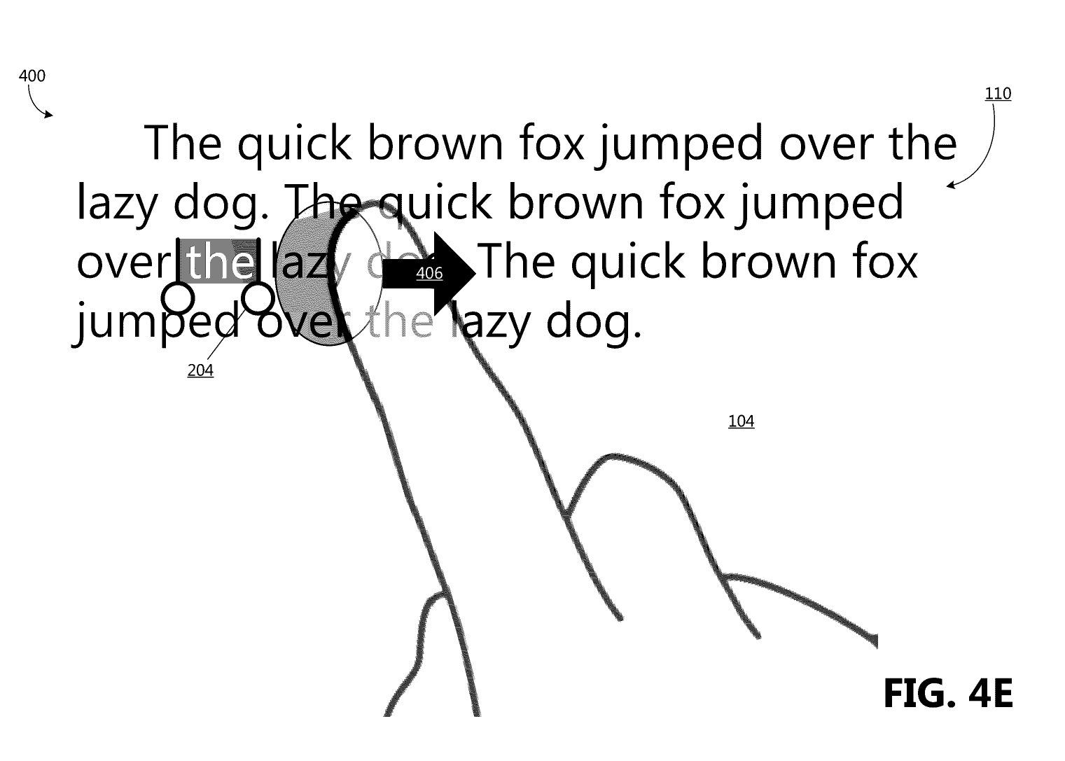

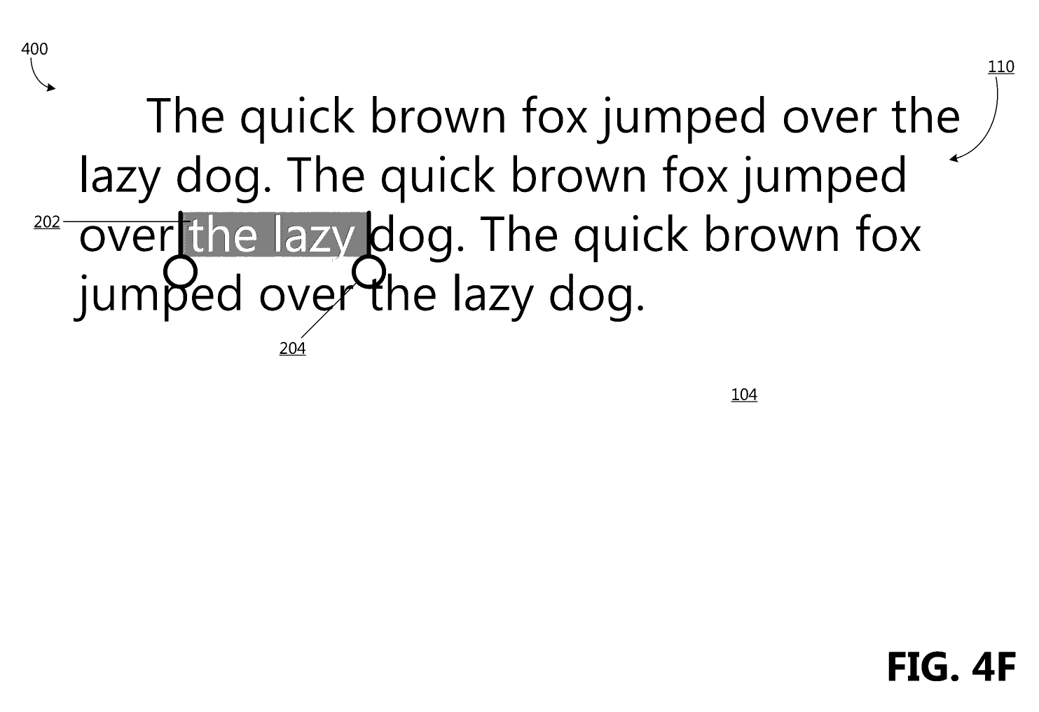

The target selector 314 is further operative to notify the application 108 of the gesture input and the determined target element. Accordingly, the application 108 is enabled to process the gesture input and perform an action according to the identified gesture input and the intended target element. For example, if the target element is determined to be the selection handle 204 and the gesture input includes a drag gesture, the application 108 is operative to modify or adjust the selected content or modify or adjust the selection 202 defined by the selection handle 204. Other examples will be described below with respect to FIGS. 4A-6F.

According to an aspect, by determining whether the amount of overlap of the selection point area 212 and the hit target 206 meets or exceeds a first predetermined threshold overlap value and is less than a second predetermined threshold overlap value, and using the determination in association with an identified gesture input, the target element selection engine 116 is enabled to prioritize certain gestures that are intended to manipulate the selection handle 204, while allowing other gestures to fall through to neighboring content 210 proximate to the selection handle 204. Accordingly, conflicts with neighboring content 210 are reduced, and accuracy when manipulating text an object selection handles 204 is increased. Additionally, the threshold overlap value required between the selection point area 212 and the hit target 206 to target a selection handle 204 can be reduced without having negative consequences on the ability to select the selection handle 204 or to interact with the neighboring content 210. Thus, the target element selection engine 116 improves functionality of the computing device 102 with improved accuracy of target element selection.

Having described an operating environment and various components of the target element selection engine 116 with respect to FIGS. 1-3, FIGS. 4A-6F illustrate various examples of gesture-dependent hit testing scenarios. With reference now to FIG. 4A, a first example 400 shows content 110 displayed on a display screen 104 and a selected piece of the content. The selection 202 includes the text string “the” as indicated by the two selection handles 204 displayed on the endpoints of the selection 202. As described above, the selection handles 204 provide an indication to the user and to the application 108 that an object is currently selected and ready for further input, such as adjustment or modification. A hit target 206 defining the selectable area associated with a selection handle 204 is illustrated as a box neighboring the selection handle 204. As should be appreciated, the hit target 206 is provided in the example 400 for purposes of illustration. The hit targets 206 may or may not be displayed on the display screen 104.

With reference now to FIG. 4B, the example 400 shows a user touching the display screen 104 in a location proximate to a selection handle 204. At this point, it is undetermined whether the intended target of the user's gesture is the selection handle 204 or the neighboring content 210 near the selection handle 204.

With reference now to FIG. 4C, the example 400 shows a selection point area 212 associated with the user's gesture input. As illustrated, the selection point area 212 and the selection handle hit target 206 overlap. The overlap 402 is indicated by the hatched area.

According to the illustrated example 400, if the first threshold overlap value is predetermined to be 1% and the second threshold overlap value is predetermined to be 100%, the hit tester 310 would analyze the overlap 402, and make a determination that the selection point area 212 exceeds the first threshold overlap value and does not exceed the second threshold overlap value. That is, there is overlap, but the selection point area 212 does not fully overlap the selection handle hit target 206. Accordingly, the hit tester 310 determines that the gesture input is a “hit around” with respect to the selection handle 204, and the gesture recognizer 312 is utilized to determine whether the gesture input is a static gesture or a manipulation gesture.

If the gesture input does not include a manipulation gesture, the gesture recognizer 312 is operative to determine that the gesture input is a static gesture, such as a tap gesture. Accordingly, the target selector 314 prioritizes the neighboring content 210, and makes a determination that the intended target element is the neighboring content 210. As illustrated in FIG. 4D, the application 108 is notified, and places an insertion point 404 in the text (i.e., neighboring content 210) at a center point of the selection point area 212.

If the gesture input includes a manipulation gesture 406 (e.g., drag gesture), for example, as illustrated in FIG. 4E, the gesture recognizer 312 is operative to determine that the gesture input is a manipulation gesture 406. Accordingly, the target selector 314 prioritizes the selection handle 204, and makes a determination that the intended target element is the selection handle 204. As illustrated in FIG. 4F, the application 108 is notified, and moves the selection handle 204, thus extending the selection 202.

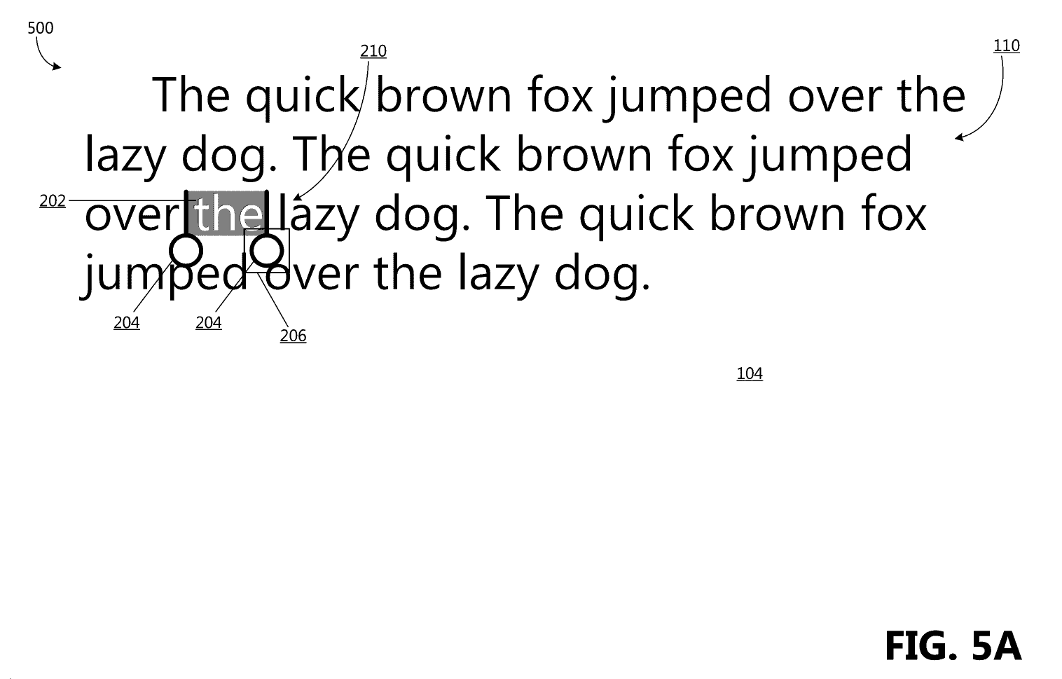

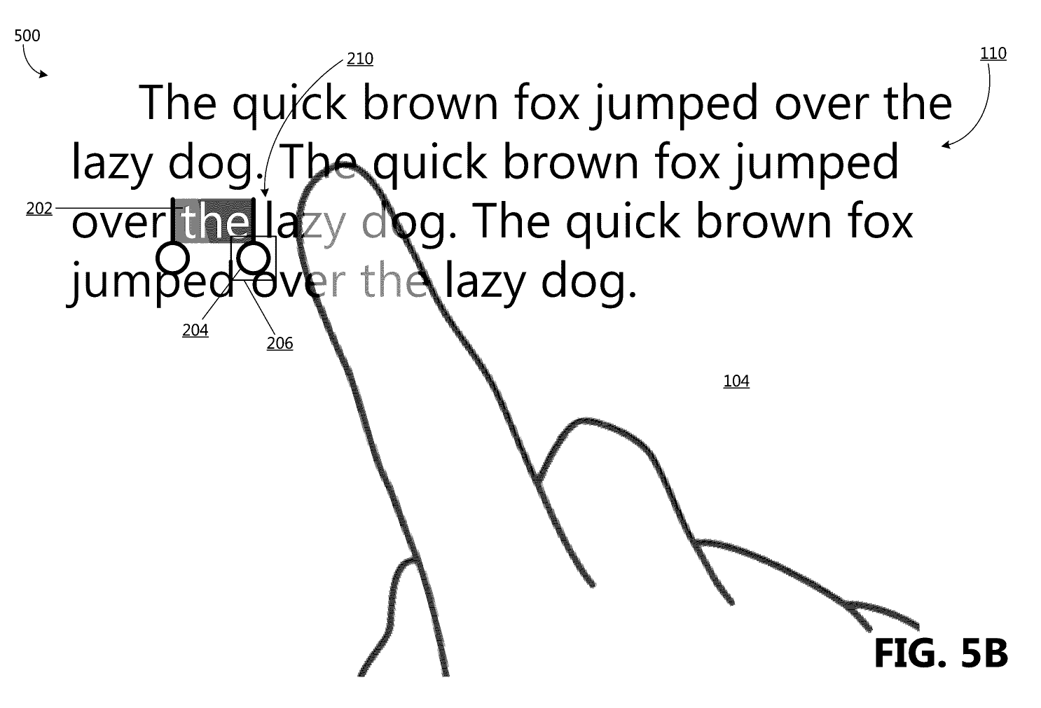

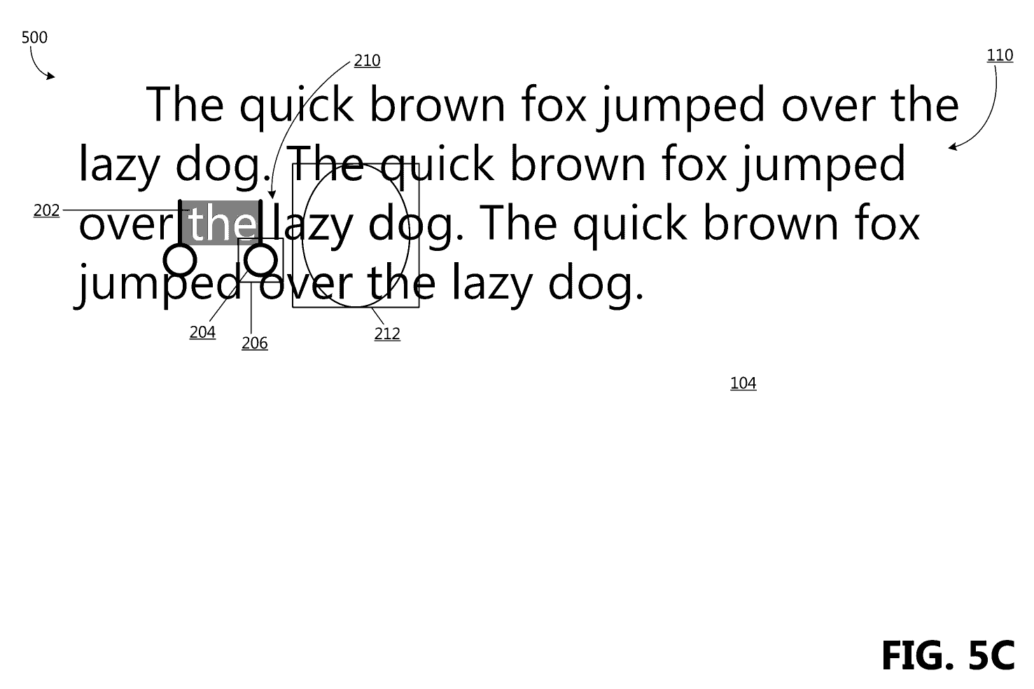

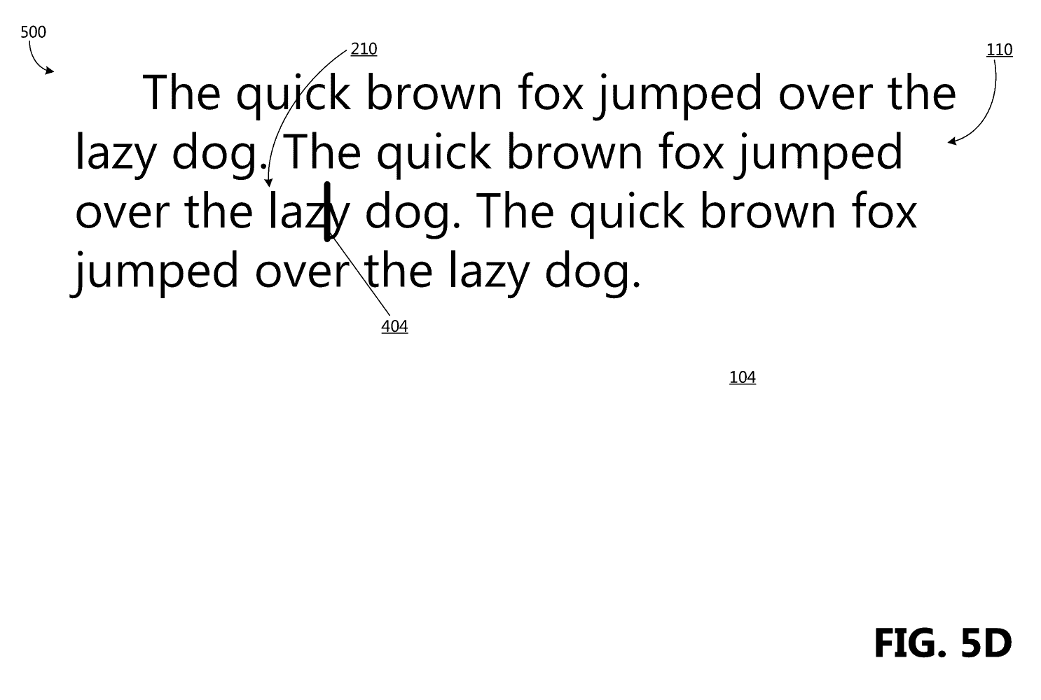

With reference now to FIG. 5A, a next example 500 shows content 110 displayed on a display screen 104 and a selected piece of the content. The selection 202 includes the text string “the” as indicated by the two selection handles 204 displayed on the endpoints of the selection 202. A hit target 206 defining the selectable area associated with a selection handle 204 is illustrated as a box neighboring the selection handle 204. As should be appreciated, the hit target 206 is provided in the example 500 for purposes of illustration. The hit targets 206 may or may not be displayed on the display screen 104.

With reference now to FIG. 5B, the example 500 shows a user touching the display screen 104 in a location proximate to a selection handle 204. At this point, it is undetermined whether the intended target of the user's gesture is the selection handle 204 or the neighboring content 210 near the selection handle 204.

With reference now to FIG. 5C, the example 500 shows a selection point area 212 associated with the user's gesture input. As illustrated, the selection point area 212 and the selection handle hit target 206 do not overlap.

According to the illustrated example 500, if the first threshold overlap value is predetermined to be 1%, the hit tester 310 would analyze the selection point area 212 and the selection handle hit target 206, and make a determination that the overlap 402 (i.e., 0%) does not meet or exceed the first threshold overlap value. Accordingly, the gesture recognizer 312 is not called, and the target selector 314 makes a determination that the intended target element is the neighboring content 210. As illustrated in FIG. 5D, the application 108 is notified, and places an insertion point 404 in the text (i.e., neighboring content 210) at a center point of the selection point area 212.

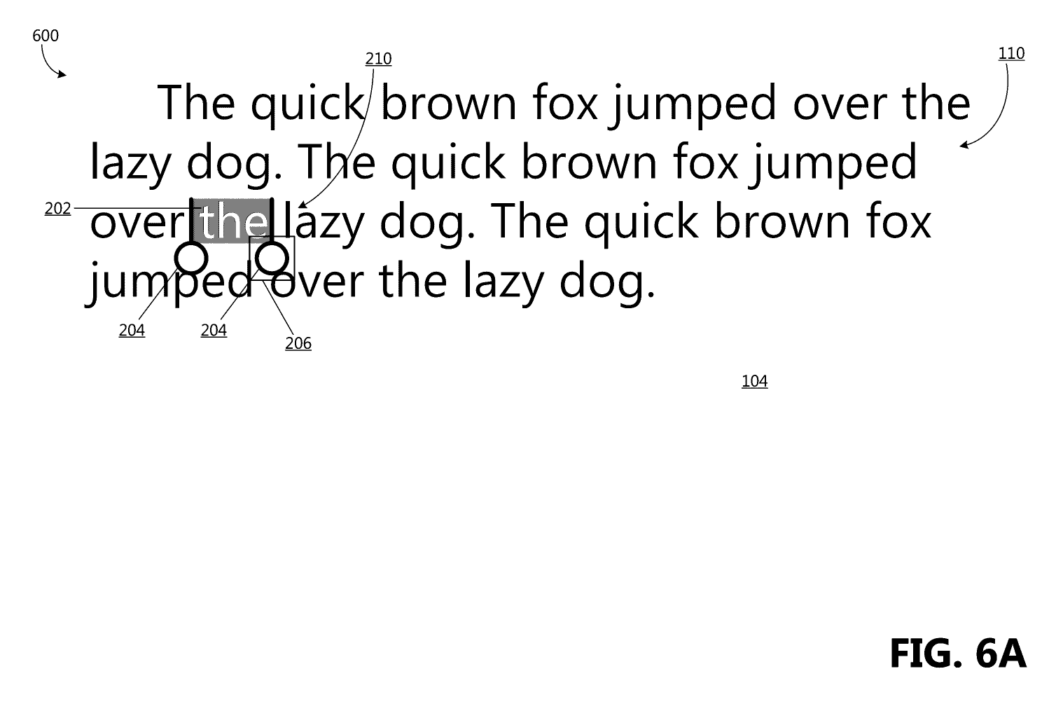

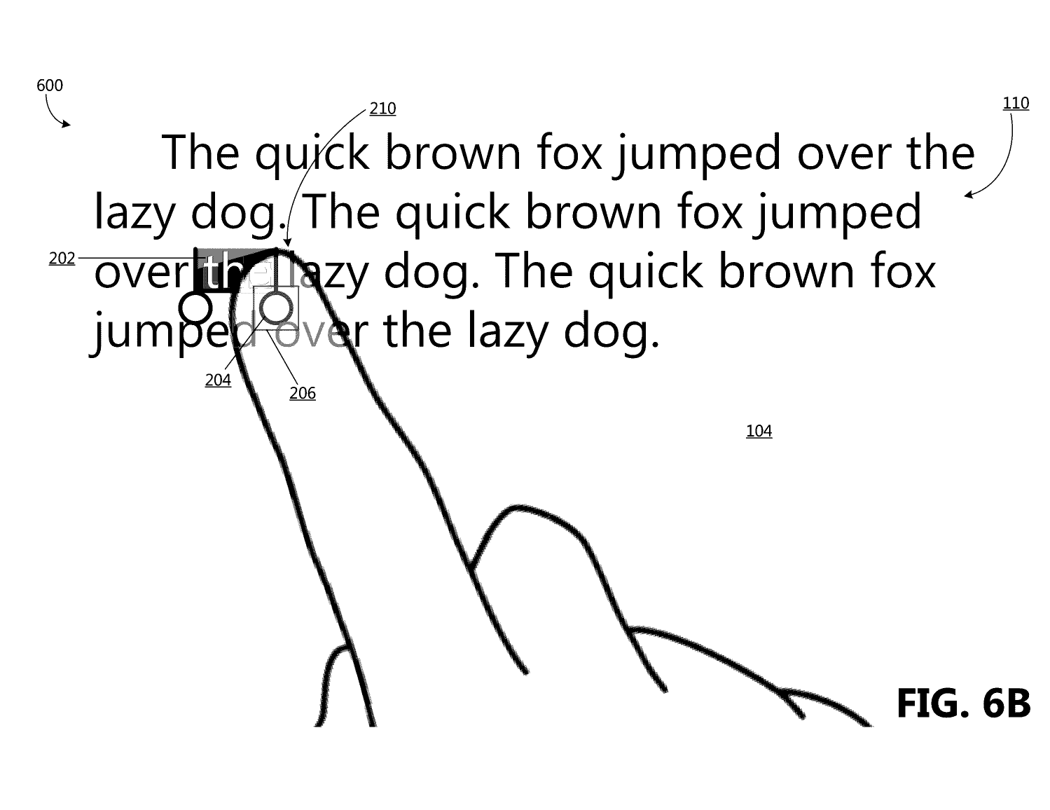

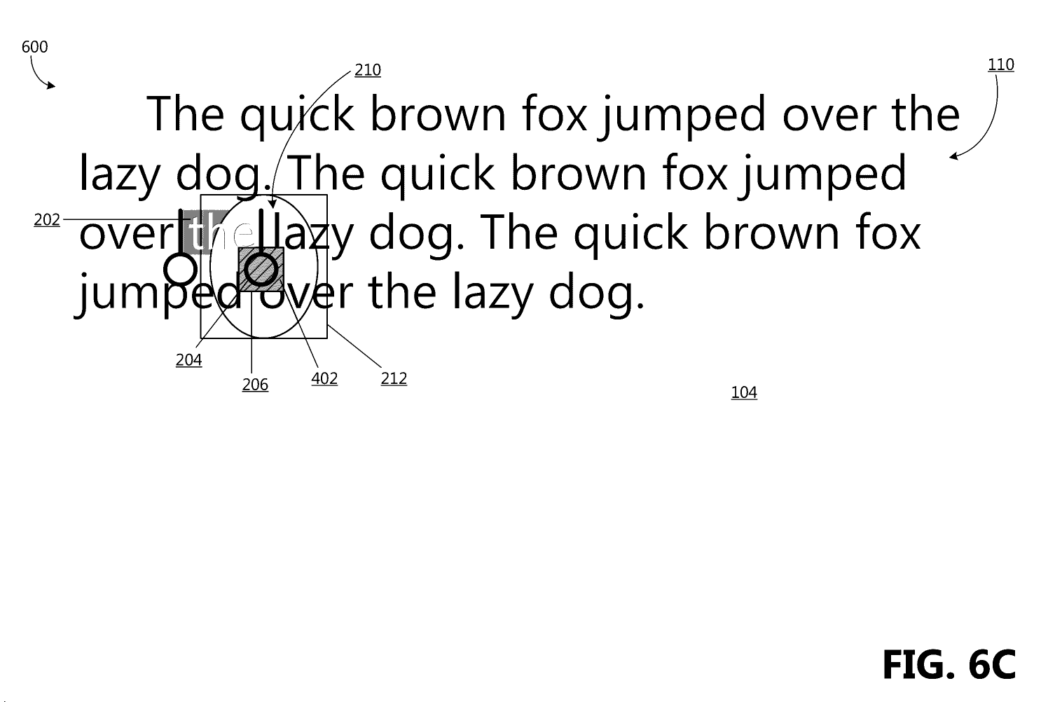

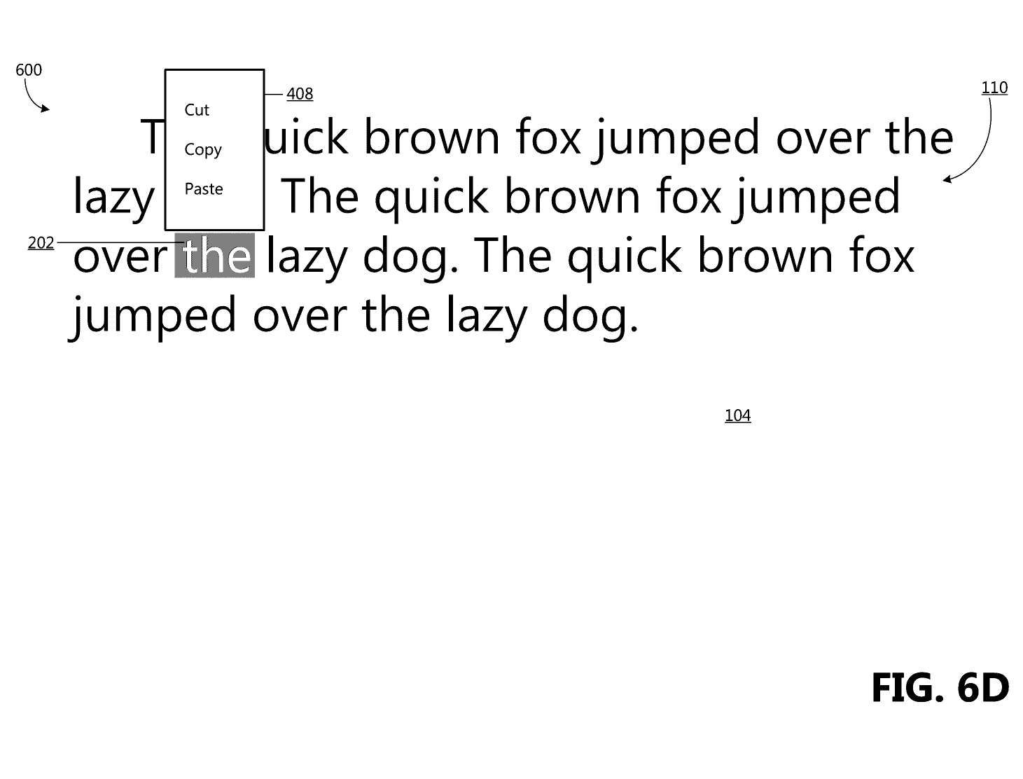

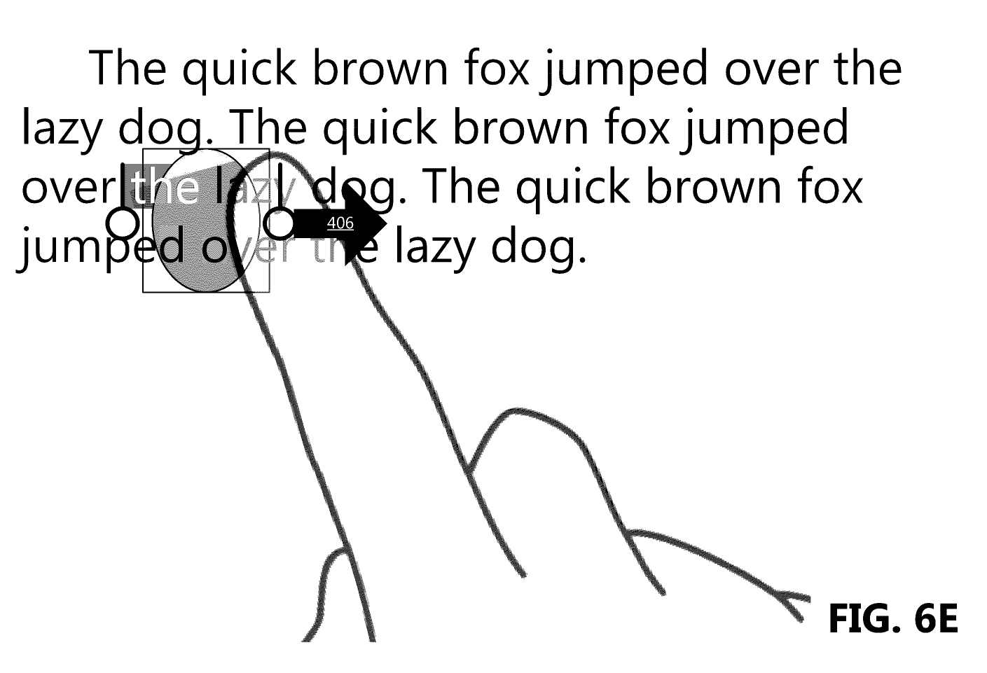

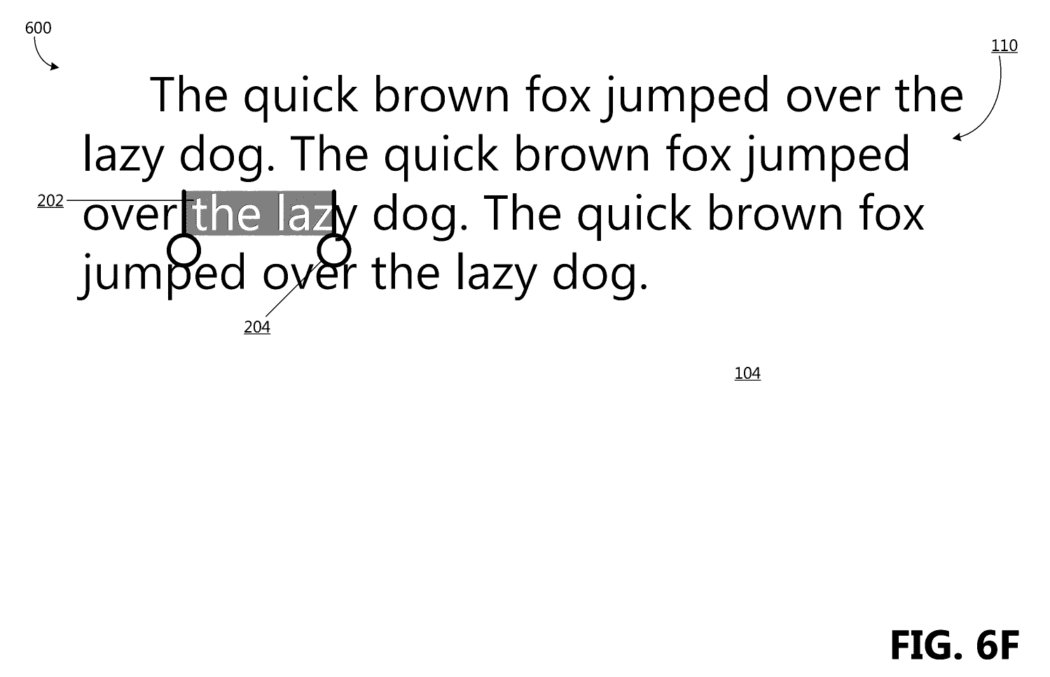

With reference now to FIG. 6A, a next example 600 shows content 110 displayed on a display screen 104 and a selected piece of the content. The selection 202 includes the text string “the” as indicated by the two selection handles 204 displayed on the endpoints of the selection 202. A hit target 206 defining the selectable area associated with a selection handle 204 is illustrated as a box neighboring the selection handle 204. As should be appreciated, the hit target 206 is provided in the example 600 for purposes of illustration. The hit targets 206 may or may not be displayed on the display screen 104.

With reference now to FIG. 6B, the example 600 shows a user touching the display screen 104 in a location proximate to or on a selection handle 204. At this point, it is undetermined whether the intended target of the user's gesture is the selection handle 204 or the neighboring content 210 near the selection handle 204.

With reference now to FIG. 6C, the example 600 shows a selection point area 212 associated with the user's gesture input. As illustrated, the selection point area 212 and the selection handle hit target 206 overlap. The overlap 402 is indicated by the hatched area.

According to the illustrated example 600, if the first threshold overlap value is predetermined to be 1% and the second threshold value is predetermined to be 100%, the hit tester 310 would analyze the overlap 402, and make a determination that the overlap 402 exceeds the first threshold overlap value and meets the second threshold overlap value. For example, the selection point area 212 fully overlaps the selection handle hit target 206. Accordingly, the target selector 314 determines that the selection handle 204 as the intended target element, and the gesture recognizer 312 is called to determine whether the gesture input is a static gesture or a manipulation gesture 406.

If the gesture input does not include a manipulation gesture 406, the gesture recognizer 312 is operative to determine that the gesture input is a static gesture, such as a tap gesture. The target selector 314 makes a determination that the gesture input is associated with interaction with the selection 202. Accordingly, and as illustrated in FIG. 6D, the application 108 is notified, and places a context menu 408 proximate to the selection 202.

If the gesture input includes a manipulation gesture 406 (e.g., drag gesture), for example, as illustrated in FIG. 6E, the gesture recognizer 312 is operative to determine that the gesture input is a manipulation gesture 406. Accordingly, the target selector 314 makes a determination that the gesture input is associated with interaction with the selection handle 204. As illustrated in FIG. 6F, the application 108 is notified, and moves the selection handle 204, thus extending the selection 202.

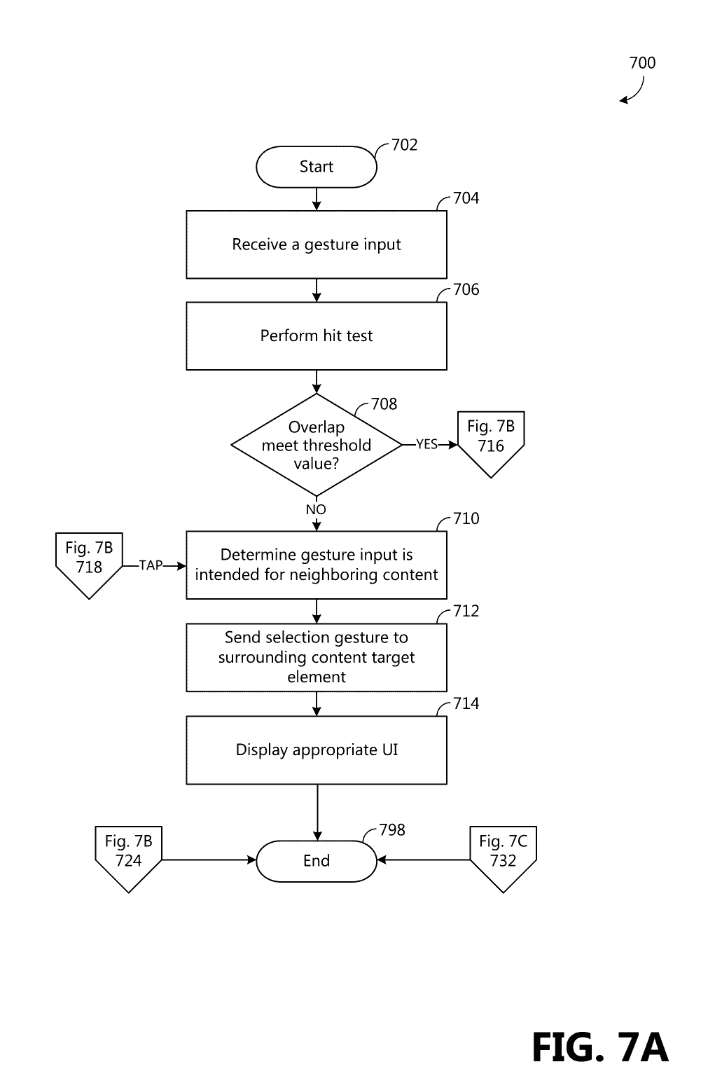

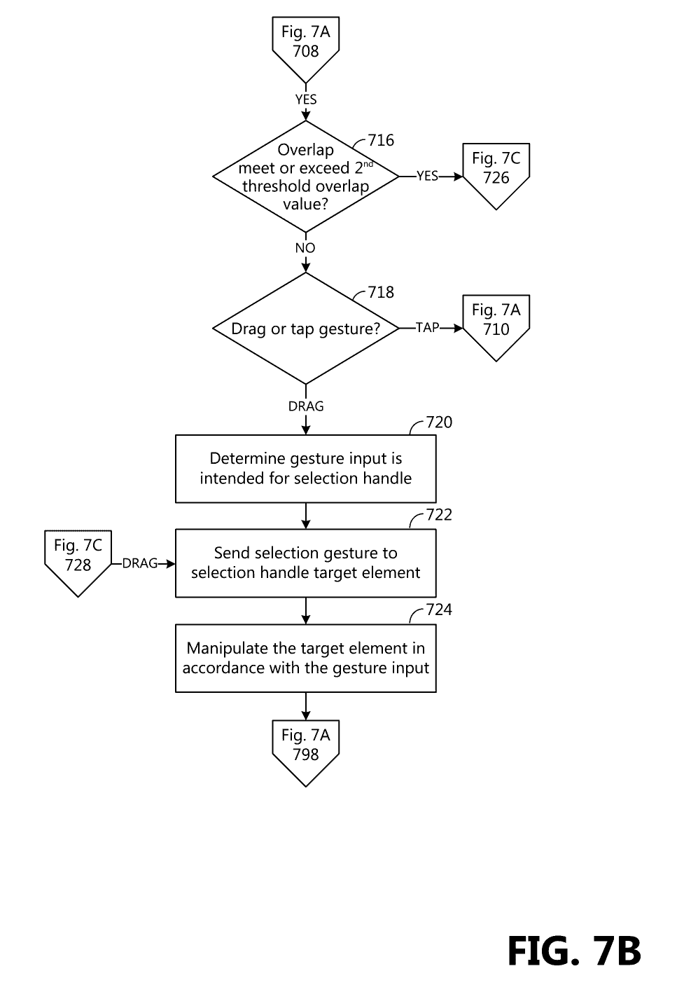

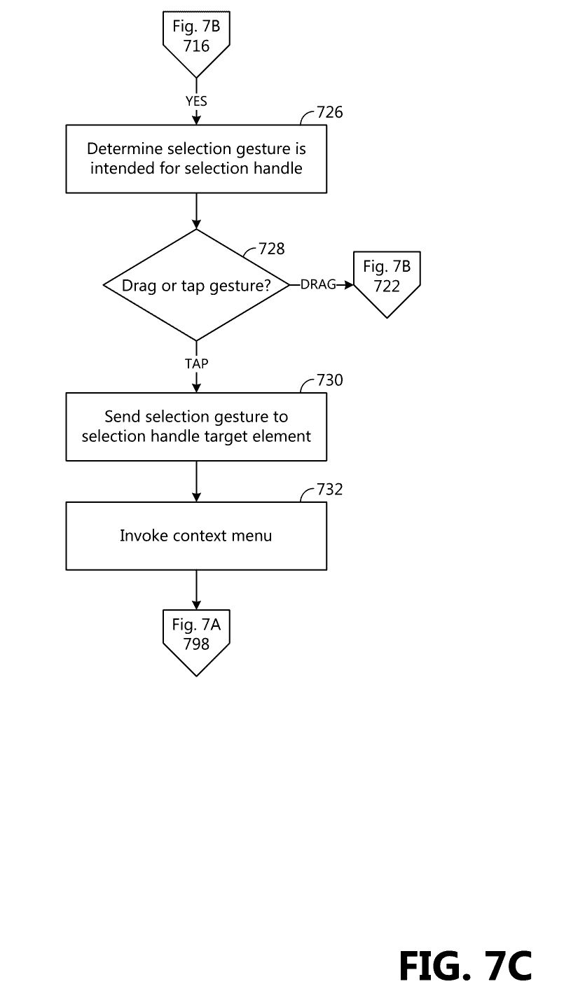

FIGS. 7A-7C are flow charts showing general stages involved in an example method 700 for gesture-dependent hit testing for target element selection. With reference now to FIG. 7A, the method 700 begins at start OPERATION 702, where one or more selection handles 204 are activated and displayed on a display screen 104. According to examples, the one or more selection handles 204 are selectable UI elements that identify a hit target 206 or a portion of a hit target 206, and provide an indication to a user and to the application 108 that an element or object is currently selected and ready for further input, such as adjustment or modification. In some examples, the one or more selection handles 204 are displayed on the two endpoints of a selected block of text (as illustrated in FIG. 2A). In other examples, the one or more selection handles 204 surround a border 208 of a selected object (as illustrated in FIG. 2B).

The method 700 proceeds to OPERATION 704, where a gesture input on or in proximity to a selection handle 204 and neighboring content 210 is received. For example, a user may contact the display screen 104 with a finger or stylus, or may direct a gesture on or in proximity to a selection handle 204 displayed on the display screen 104 via an air gesture, head motion, or eye gaze. The input gesture is translated into an input message via the input device controller 114, and communicated to the event message receiver 308 via the input driver 115. The input message comprises various pieces of information associated with the gesture input, such as coordinates of where on the display screen 104 the gesture input occurred, an identifier for the gesture input, and dimensions of the selection point area 212.

The method 700 proceeds to OPERATION 706, where the hit tester 310 performs a hit test for determining whether the selection point area 212 overlaps the selection handle hit target 206, and if so, by how much. According to examples, the application 108 provides information to the hit tester 310, such as coordinates of the locations of selection handles 204 and the coordinates of the hit targets 206 associated with the selection handles 204.

At DECISION OPERATION 708, the hit tester 310 makes a determination as to whether there is an overlap 402 between the selection point area 212 and the selection handle hit target 206. If there is an overlap 402, the hit tester 310 compares the amount of overlap with a predetermined threshold overlap value, and determines whether the amount of overlap 402 meets or exceeds the predetermined threshold overlap value. In some examples, the predetermined threshold overlap value is 1%, such that a positive determination is made if there is any overlap 402. If there is not an overlap 402 or if the overlap 402 does not meet or exceed the predetermined threshold overlap value, the method 700 proceeds to OPERATION 710, where the target selector 314 determines that the gesture input is intended for neighboring content 210 (e.g., content near the selection handle 204).

At OPERATION 712, the target selector 314 sends a notification to the application 108 of the gesture input and the determined target element (i.e., neighboring content 210). The method 700 proceeds to OPERATION 714, where the application 108 processes the gesture input, and places an insertion point 404 on the neighboring content 210.

If a determination is made that the overlap 402 between the selection point area 212 and the selection handle hit target 206 meets or exceeds the predetermined threshold overlap value at DECISION OPERATION 708, the method 700 proceeds to DECISION OPERATION 716 on FIG. 7B, where the hit tester 310 determines whether the amount of overlap 402 meets or exceeds a second predetermined threshold overlap value. In some examples, the second predetermined threshold overlap value is 100% (e.g., full overlap).

If a determination is made that the overlap 402 does not meet or exceed the second predetermined threshold overlap value at DECISION OPERATION 716, the method 700 proceeds to DECISION OPERATION 718, where the gesture recognizer makes a determination as to whether the gesture input includes a static gesture or a manipulation gesture 406. For example, the gesture input may be a single gesture event (e.g., a tap gesture), or may be a gesture sequence comprising a plurality of gesture events (e.g., a selection gesture and a drag gesture).

If a determination is made that the gesture input is a manipulation gesture 406 (e.g., a drag gesture), the method 700 proceeds to OPERATION 720, where the target selector 314 determines that the gesture input is intended for the selection handle 204.

At OPERATION 722, the target selector 314 sends a notification to the application 108 of the gesture input and the determined target element (i.e., selection handle 204). The method 700 proceeds to OPERATION 724, where the application 108 processes the gesture input, moves the selection handle 204 according to the input, and adjusts the selection 202 (e.g., extends the selection, contracts the selection, resizes the selected object).

If a determination is made that the gesture input is a static gesture (e.g., tap gesture) at DECISION OPERATION 718, the method 700 continues to OPERATION 710 on FIG. 7A, where the target selector 314 determines that the gesture input is intended for neighboring content 210 (e.g., content near the selection handle 204), as described above.

With reference again to FIG. 7B, if a determination is made that the overlap 402 does meet or exceed the second predetermined threshold overlap value at DECISION OPERATION 716, the method 700 proceeds to OPERATION 726 on FIG. 7C, where the target selector 314 determines that the gesture input is intended for the selection handle 204.

The method proceeds to DECISION OPERATION 728, where the gesture recognizer makes a determination as to whether the gesture input includes a static gesture or a manipulation gesture 406. For example, the gesture input may be a single gesture event (e.g., a tap gesture), or may be a gesture sequence comprising a plurality of gesture events (e.g., a selection gesture and a drag gesture).

If a determination is made that the gesture input is a manipulation gesture 406 (e.g., a drag gesture) at DECISION OPERATION 728, the method 700 continues to OPERATION 722 on FIG. 7B, where the target selector 314 sends a notification to the application 108 of the gesture input and the determined target element (i.e., selection handle 204) as described above.

If a determination is made that the gesture input is a static gesture (e.g., tap gesture) at DECISION OPERATION 728, the method 700 proceeds to OPERATION 730, where the target selector 314 sends a notification to the application 108 of the gesture input and the determined target element (i.e., selection handle 204). At OPERATION 732, the application 108 processes the gesture input, and invokes a context menu 408 for display on the display screen 104. The method 700 ends at OPERATION 798.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

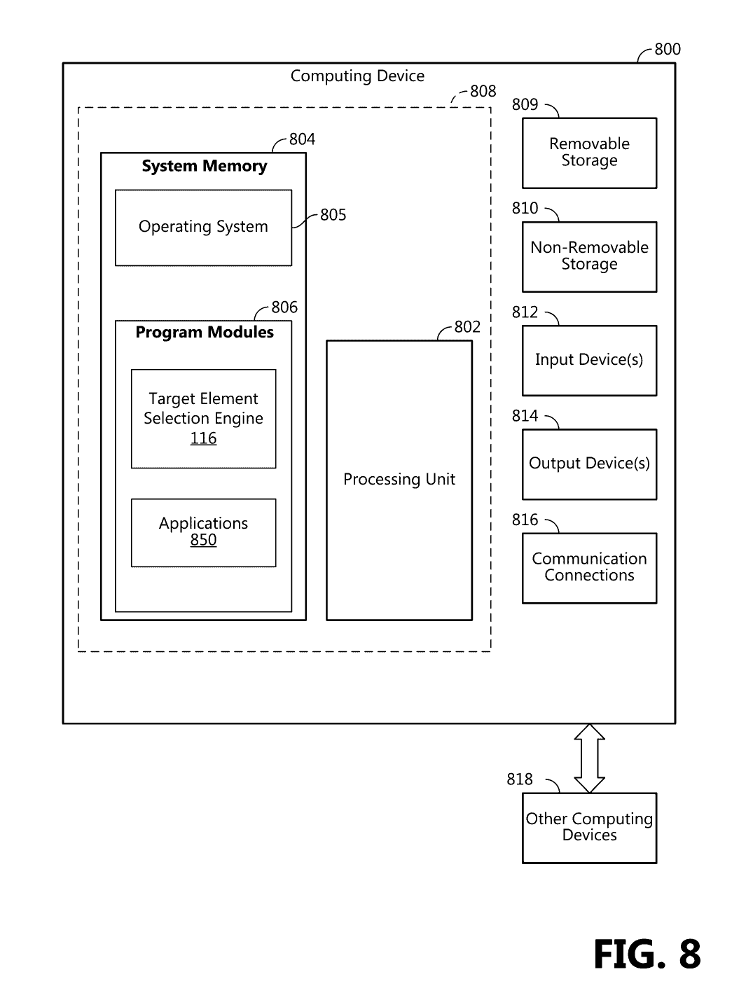

FIGS. 8-10 and the associated descriptions provide a discussion of a variety of operating environments in which examples are practiced. However, the devices and systems illustrated and discussed with respect to FIGS. 8-10 are for purposes of example and illustration and are not limiting of a vast number of computing device configurations that are utilized for practicing aspects, described herein.

FIG. 8 is a block diagram illustrating physical components (i.e., hardware) of a computing device 800 with which examples of the present disclosure are be practiced. In a basic configuration, the computing device 800 includes at least one processing unit 802 and a system memory 804. According to an aspect, depending on the configuration and type of computing device, the system memory 804 comprises, but is not limited to, volatile storage (e.g., random access memory), non-volatile storage (e.g., read-only memory), flash memory, or any combination of such memories. According to an aspect, the system memory 804 includes an operating system 805 and one or more program modules 806 suitable for running software applications 850. According to an aspect, the system memory 804 includes the target element selection engine 116. The operating system 805, for example, is suitable for controlling the operation of the computing device 800. Furthermore, aspects are practiced in conjunction with a graphics library, other operating systems, or any other application program, and is not limited to any particular application or system. This basic configuration is illustrated in FIG. 8 by those components within a dashed line 808. According to an aspect, the computing device 800 has additional features or functionality. For example, according to an aspect, the computing device 800 includes additional data storage devices (removable and/or non-removable) such as, for example, magnetic disks, optical disks, or tape. Such additional storage is illustrated in FIG. 8 by a removable storage device 809 and a non-removable storage device 810.

As stated above, according to an aspect, a number of program modules and data files are stored in the system memory 804. While executing on the processing unit 802, the program modules 806 (e.g., target element selection engine 116) perform processes including, but not limited to, one or more of the stages of the method 700 illustrated in FIGS. 7A-C. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 8 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 800 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 800 has one or more input device(s) 812 such as a keyboard, a mouse, a pen, a sound input device, a touch input device, etc. The output device(s) 814 such as a display, speakers, a printer, etc. are also included according to an aspect. The aforementioned devices are examples and others may be used. According to an aspect, the computing device 800 includes one or more communication connections 816 allowing communications with other computing devices 818. Examples of suitable communication connections 816 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. According to an aspect, any such computer storage media is part of the computing device 800. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

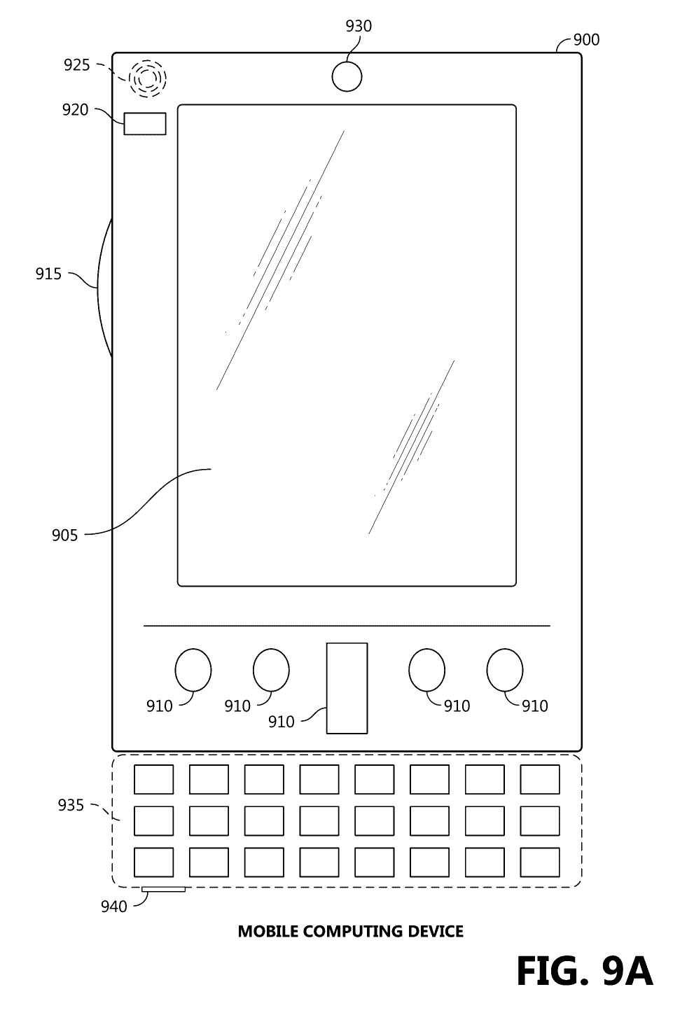

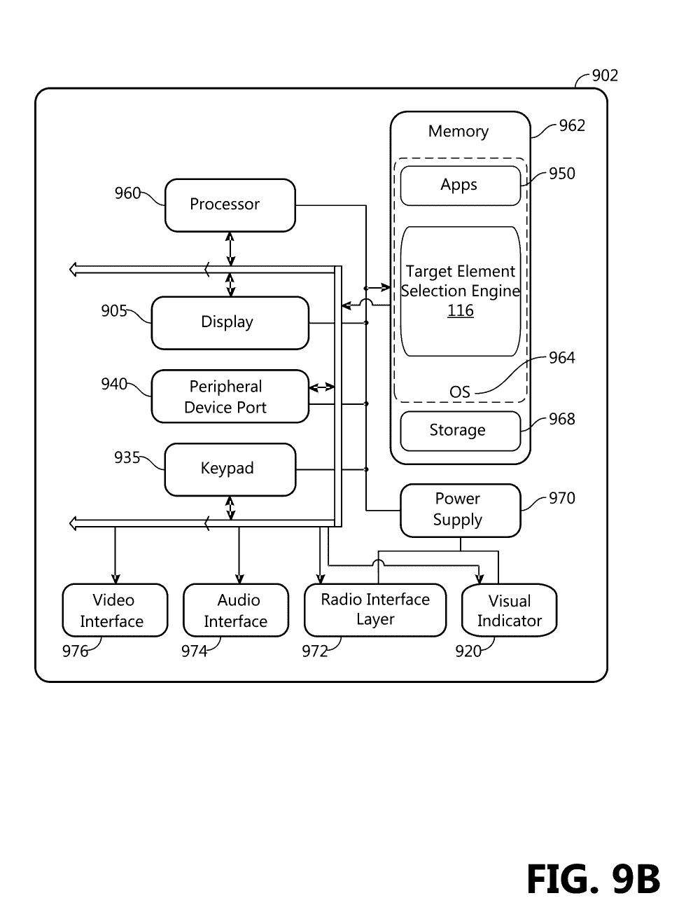

FIGS. 9A and 9B illustrate a mobile computing device 900, for example, a mobile telephone, a smart phone, a tablet personal computer, a laptop computer, and the like, with which aspects may be practiced. With reference to FIG. 9A, an example of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. According to an aspect, the display 905 of the mobile computing device 900 functions as an input device (e.g., a touch screen display). If included, an optional side input element 915 allows further user input. According to an aspect, the side input element 915 is a rotary switch, a button, or any other type of manual input element. In alternative examples, mobile computing device 900 incorporates more or less input elements. For example, the display 905 may not be a touch screen in some examples. In alternative examples, the mobile computing device 900 is a portable phone system, such as a cellular phone. According to an aspect, the mobile computing device 900 includes an optional keypad 935. According to an aspect, the optional keypad 935 is a physical keypad. According to another aspect, the optional keypad 935 is a “soft” keypad generated on the touch screen display. In various aspects, the output elements include the display 905 for showing a graphical user interface (GUI), a visual indicator 920 (e.g., a light emitting diode), and/or an audio transducer 925 (e.g., a speaker). In some examples, the mobile computing device 900 incorporates a vibration transducer for providing the user with tactile feedback. In yet another example, the mobile computing device 900 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 900 incorporates peripheral device port 940, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one example of a mobile computing device. That is, the mobile computing device 900 incorporates a system (i.e., an architecture) 902 to implement some examples. In one example, the system 902 is implemented as a “smart phone” capable of running one or more applications (e.g., browser, e-mail, calendaring, contact managers, messaging clients, games, and media clients/players). In some examples, the system 902 is integrated as a computing device, such as an integrated personal digital assistant (PDA) and wireless phone.

According to an aspect, one or more application programs 950 are loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. According to an aspect, the target element selection engine 116 is loaded into memory 962. The system 902 also includes a non-volatile storage area 968 within the memory 962. The non-volatile storage area 968 is used to store persistent information that should not be lost if the system 902 is powered down. The application programs 950 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900.

According to an aspect, the system 902 has a power supply 970, which is implemented as one or more batteries. According to an aspect, the power supply 970 further includes an external power source, such as an AC adapter or a powered docking cradle that supplements or recharges the batteries.

According to an aspect, the system 902 includes a radio 972 that performs the function of transmitting and receiving radio frequency communications. The radio 972 facilitates wireless connectivity between the system 902 and the “outside world,” via a communications carrier or service provider. Transmissions to and from the radio 972 are conducted under control of the operating system 964. In other words, communications received by the radio 972 may be disseminated to the application programs 950 via the operating system 964, and vice versa.

According to an aspect, the visual indicator 920 is used to provide visual notifications and/or an audio interface 974 is used for producing audible notifications via the audio transducer 925. In the illustrated example, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. According to an aspect, the system 902 further includes a video interface 976 that enables an operation of an on-board camera 930 to record still images, video stream, and the like.

According to an aspect, a mobile computing device 900 implementing the system 902 has additional features or functionality. For example, the mobile computing device 900 includes additional data storage devices (removable and/or non-removable) such as, magnetic disks, optical disks, or tape. Such additional storage is illustrated in FIG. 9B by the non-volatile storage area 968.

According to an aspect, data/information generated or captured by the mobile computing device 900 and stored via the system 902 is stored locally on the mobile computing device 900, as described above. According to another aspect, the data is stored on any number of storage media that is accessible by the device via the radio 972 or via a wired connection between the mobile computing device 900 and a separate computing device associated with the mobile computing device 900, for example, a server computer in a distributed computing network, such as the Internet. As should be appreciated such data/information is accessible via the mobile computing device 900 via the radio 972 or via a distributed computing network. Similarly, according to an aspect, such data/information is readily transferred between computing devices for storage and use according to well-known data/information transfer and storage means, including electronic mail and collaborative data/information sharing systems.

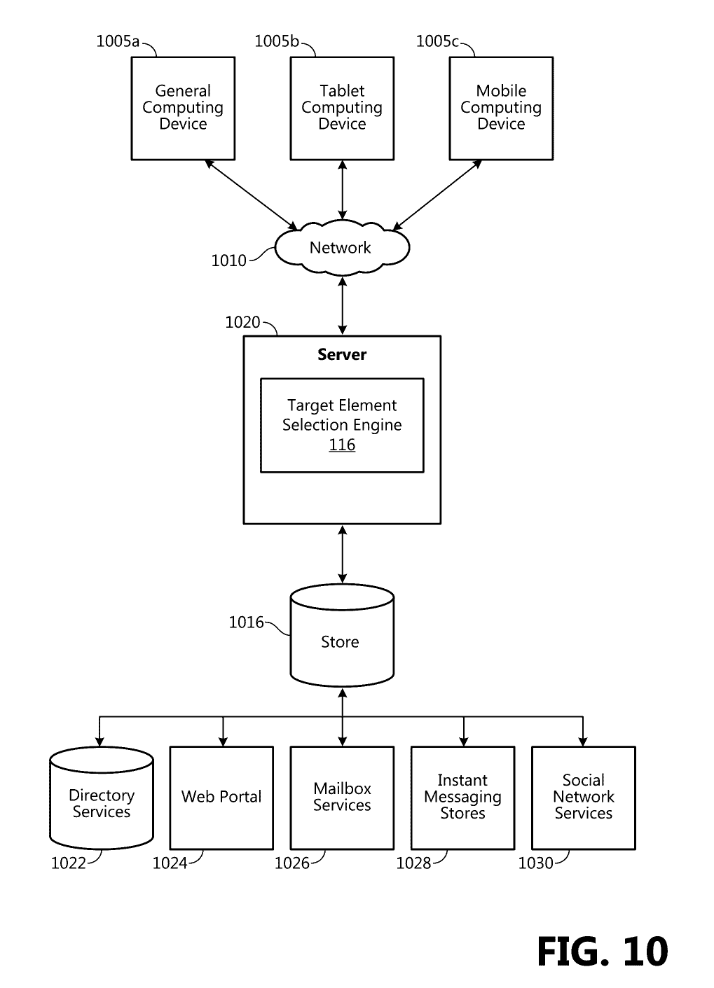

FIG. 10 illustrates one example of the architecture of a system for selecting an intended target element via gesture-dependent hit testing as described above. Content developed, interacted with, or edited in association with the target element selection engine 116 is enabled to be stored in different communication channels or other storage types. For example, various documents may be stored using a directory service 1022, a web portal 1024, a mailbox service 1026, an instant messaging store 1028, or a social networking site 1030. The target element selection engine 116 is operative to use any of these types of systems or the like for selecting an intended target element via gesture-dependent hit testing, as described herein. According to an aspect, a server 1020 provides the target element selection engine 116 to clients 1005a,b,c. As one example, the server 1020 is a web server providing the target element selection engine 116 over the web. The target element selection engine 116 provides the target element selection engine 116 over the web to clients 1005 through a network 1010. By way of example, the client computing device is implemented and embodied in a personal computer 1005a, a tablet computing device 1005b or a mobile computing device 1005c (e.g., a smart phone), or other computing device. Any of these examples of the client computing device are operable to obtain content from the store 1016.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for improving functionality of a natural user interface of a computing device, comprising:
receiving a gesture input at a selection point area on or proximate to a selection handle and neighboring content displayed on a display screen, wherein the selection handle is displayed with at least one additional selection handle and provides an indication of currently-selected content;
performing a hit test to determine whether the selection point area associated with the gesture input overlaps a hit target associated with the selection handle;
in response to a positive determination, determining whether the gesture input includes a static gesture or a manipulation gesture; and
when a determination is made that the gesture input includes a manipulation gesture:
selecting an intended target element at the selection handle; and
manipulating the intended target element in accordance with the manipulation gesture.

2. The computer-implemented method of claim 1, wherein determining whether the gesture input includes a manipulation gesture comprises determining whether the gesture input comprises a drag gesture.

3. The computer-implemented method of claim 1, wherein the positive determination comprises:
determining that an overlap of the selection point area and the hit target meets or exceeds a first predetermined threshold value; and
determining that the overlap of the selection point area and the hit target is less than a second predetermined threshold value.

4. The computer-implemented method of claim 3, wherein:
determining that an overlap of the selection point area and the hit target meets or exceeds a first predetermined threshold value comprises determining that the selection point area and the hit target overlap by at least 1%; and
determining that the overlap of the selection point area and the hit target is less than a second predetermined threshold value comprises determining that the selection point area and the hit target overlap by less than 100%.

5. The computer-implemented method of claim 4, wherein manipulating the intended target element in accordance with the manipulation gesture comprises moving the selection handle for modifying an amount of currently-selected content.

6. The computer-implemented method of claim 4, wherein manipulating the intended target element in accordance with the manipulation gesture comprises moving the selection handle for resizing the currently-selected content.

7. The computer-implemented method of claim 1, wherein determining whether the gesture input includes a static gesture comprises determining whether the gesture input comprises a tap gesture.

8. The computer-implemented method of claim 7, further comprising:
when a determination is made that the gesture input includes a static gesture, selecting an intended target element at the neighboring content; and
inserting an insertion point at the neighboring content.

9. The computer-implemented method of claim 1, wherein the positive determination comprises:
determining that an overlap of the selection point area and the hit target meets or exceeds a first predetermined threshold value; and
determining that the overlap of the selection point area and the hit target is meets or exceeds a second predetermined threshold value.

10. The computer-implemented method of claim 9, further comprising:
when a determination is made that the gesture input includes a static gesture, selecting an intended target element at the selection handle; and
invoking a contextual menu at the selection handle.

11. A system for improving functionality of a natural user interface of a computing device, comprising:
one or more processors for executing programmed instructions;
memory, coupled to the one or more processors, for storing program instruction steps for execution by the computer processor;
a display screen operative to receive natural user interface input; and
a target element selection engine comprising:
an event message receiver operative to receive a gesture input at a selection point area on or proximate to a selection handle and neighboring content displayed on a display screen, wherein the selection handle is displayed with at least one additional selection handle and provides an indication of currently-selected content;
a hit tester operative to perform a hit test to determine whether the selection point area associated with the gesture input overlaps a hit target associated with the selection handle; and
a gesture recognizer operative to determine whether the gesture input includes a static gesture or a manipulation gesture in response to a positive determination by the hit tester; and
an application executing on the computing device, which when a determination is made that the gesture input includes a manipulation gesture, is operative to:
select an intended target element at the selection handle; and
manipulate the intended target element in accordance with the manipulation gesture.

12. The system of claim 11, wherein the hit tester is operative to positively determine that the selection point area associated with the gesture input overlaps the hit target associated with the selection handle when:
an overlap of the selection point area and the hit target meets or exceeds a first predetermined threshold value; and
the overlap of the selection point area and the hit target is less than a second predetermined threshold value.

13. The system of claim 12, wherein in manipulating the intended target element in accordance with the manipulation gesture, the application is operative to move the selection handle for modifying an amount of currently-selected content.

14. The system of claim 12, wherein in manipulating the intended target element in accordance with the manipulation gesture, the application is operative to move the selection handle for resizing the currently-selected content.

15. The system of claim 11, wherein:
in determining whether the gesture input includes a manipulation gesture, the gesture recognizer is operative to determine whether the gesture input comprises a drag gesture.
in determining whether the gesture input includes a static gesture, the gesture recognizer is operative to determine whether the gesture input comprises a tap gesture.

16. The system of claim 15, wherein the application if further operative to:
select an intended target element at the neighboring content when a determination is made that the gesture input includes a static gesture; and
insert an insertion point at the neighboring content.

17. The system of claim 11, wherein the hit tester is the hit tester is operative to positively determine that the selection point area associated with the gesture input overlaps the hit target associated with the selection handle when:
an overlap of the selection point area and the hit target meets or exceeds a first predetermined threshold value; and
the overlap of the selection point area and the hit target is meets or exceeds a second predetermined threshold value.

18. The system of claim 17, wherein when a determination is made that the gesture input includes a static gesture, the application is further operative to:
select an intended target element at the selection handle; and
invoke a contextual menu at the selection handle.

19. A device for improving functionality of a natural user interface of a computing device, the device comprising:
one or more processors for executing programmed instructions;
memory, coupled to the one or more processors, for storing program instruction steps for execution by the computer processor;
a display screen operative to receive natural user interface input; and
a target element selection engine operative to:
receive a gesture input at a selection point area on or proximate to a selection handle and neighboring content displayed on a display screen, wherein the selection handle is displayed with at least one additional selection handle and provides an indication of currently-selected content;
perform a first hit test to determine whether the selection point area associated with the gesture input overlaps a hit target associated with the selection handle by at least a first predetermined threshold value and less than a second predetermined threshold value;
in response to a positive determination of the first hit test,
determine whether the gesture input includes a tap gesture or a drag gesture;
when a determination is made that the gesture input includes a drag gesture:
select an intended target element at the selection handle; and
manipulate the intended target element in accordance with the manipulation gesture; and
when a determination is made that the gesture input includes a tap gesture:
select an intended target element at the neighboring content; and
insert an insertion point at the neighboring content.

20. The device of claim 19, wherein in response to a negative determination of the first hit test, the target element selection engine is further operative to:
perform a second hit test to determine whether the selection point area associated with the gesture input overlaps the hit target associated with the selection handle by at least the first predetermined threshold value and at least the second predetermined threshold value;
in response to a positive determination of the second hit test:
select the intended target element at the selection handle; and
determine whether the gesture input includes a tap gesture or a drag gesture;
when a determination is made that the gesture input includes a drag gesture, manipulate the intended target element in accordance with the manipulation gesture; and
when a determination is made that the gesture input includes a tap gesture, insert an insertion point at the neighboring content.
